(19) United States
(12) Patent Application Publication
(10) Pub. No.: US 2025/0095400 A1
(43) Pub. Date: Mar. 20, 2025

(54) IMAGE PROCESSING APPARATUS, IMAGE PROCESSING METHOD AND NON-TRANSITORY RECORDING MEDIUM

(71) Applicant: NEC Corporation, Minato-ku, Tokyo (JP)

(72) Inventor: Kazuyuki SASAKI, Tokyo (JP)

(73) Assignee: NEC Corporation, Minato-ku, Tokyo (JP)

(21) Appl. No.: 18/728,917

(22) PCT Filed: Mar. 31, 2022
(86) PCT No.: PCT/JP2022/016624

§ 371 Date: Jul. 15, 2024

(51) Int. Cl. G06V 40/16; G06V 10/82

(52) U.S. Cl. CPC G06V 40/172; G06V 40/171; G06V 10/82; G06V 40/165

(57) ABSTRACT

An image processing apparatus 1 comprises: a first area detecting means 11 for detecting a first area including at least a part of a person from an image, a first feature point detecting means 12 for detecting first feature points from the first area, a second area detecting means 13 for detecting a second area including at least a part of a person from the image, wherein the second area overlapping at least a part of the first area, wherein a size of the second area being different from the first area, a second feature point detecting means 14 for detecting second feature points from the second area, and an estimating means 15 for estimating whether or not a person included in the first area and a person included in the second area are the same person on the basis of the first feature points and the second feature points.

### TECHNICAL FIELD

This disclosure relates to an image processing apparatus, an image processing method and a recording medium.

### BACKGROUND

It is described in a patent literature 1 that a technique can perform attribute determination of a person and the technique's detecting accuracy of a person is high even if a feature part of a face is hidden, wherein the technique including an image acquiring step for acquiring a determining target person image, an attribute determination area detecting step for detecting at least two attribute determination areas selected from a group including a head area, a face area and another area, an attribute determining step for determining an attribute from image of the at least two attribute determination areas. It is described in a patent literature 2 that a technique selects one of a detection result of a predetermined feature area about a predetermined part area detected from an image data by a first method and a detection result of a predetermined feature area about a predetermined part area detected from an image data by a second method as a final detection result of a feature area. It is described in a patent literature 3 that a technique in an image searching apparatus, which has a face area trimming program trimming a face area from video data, extracts a face area from video data by a first algorithm, extracts a head area from video data by a second algorithm, performs a face detection on an area, which is extracted as the head area but not as the face area, while changing image quality.

### CITATION LIST

### Patent Literature

Patent Literature 1: International Publication No. 2012/053311

Patent Literature 2: Japanese Patent Application Laid Open No. 2021-082136

Patent Literature 3: International Publication No. 2018/173947

### SUMMARY

### Technical Problem

This disclosure is to provide an image processing apparatus, an image processing method and a recording medium aiming to improve techniques described in the prior art literature.

### Solution to Problem

One aspect of an image processing apparatus comprises: a first area detecting means for detecting a first area including at least a part of a person from an image, a first feature point detecting means for detecting first feature points from the first area, a second area detecting means for detecting a second area including at least a part of a person from the image, wherein the second area overlapping at least a part of the first area, wherein a size of the second area being different from the first area, a second feature point detecting means for detecting second feature points from the second area, and an estimating means for estimating whether or not a person included in the first area and a person included in the second area are the same person on the basis of the first feature points and the second feature points.

One aspect of an image processing method includes: detecting a first area including at least a part of a person from an image, detecting first feature points from the first area, detecting a second area including at least a part of a person from the image, wherein the second area overlapping at least a part of the first area, wherein a size of the second area being different from the first area, detecting second feature points from the second area, and estimating whether or not a person included in the first area and a person included in the second area are the same person on the basis of the first feature points and the second feature points.

One aspect of a recording medium is a recording medium on which a computer program is recorded, wherein the computer program makes a computer perform an image processing method including: detecting a first area including at least a part of a person from an image, detecting first feature points from the first area, detecting a second area including at least a part of a person from the image, wherein the second area overlapping at least a part of the first area, wherein a size of the second area being different from the first area, detecting second feature points from the second area, and estimating whether or not a person included in the first area and a person included in the second area are the same person on the basis of the first feature points and the second feature points.

### BRIEF DESCRIPTION OF DRAWINGS

FIG. 1 is block diagram showing a configuration of an image processing apparatus in a first embodiment.

FIG. 2 is a block diagram showing a configuration of an image processing apparatus in a second embodiment.

FIG. 3 is a flowchart showing flow of image processing operation performed by the image processing apparatus in the second embodiment.

FIG. 4 is a conceptual scheme of the image processing operation performed by the image processing apparatus in the second embodiment.

FIG. 5 is a block diagram showing a configuration of an image processing apparatus in a third embodiment.

FIG. 6 is a flowchart showing flow of image processing operation performed by the image processing apparatus in the third embodiment.

FIG. 7 is a conceptual scheme of the image processing operation performed by the image processing apparatus in the third embodiment.

FIG. 8 is a block diagram showing a configuration of an image processing apparatus in a fifth embodiment.

FIG. 9 is a flowchart showing flow of image processing operation performed by the image processing apparatus in the fifth embodiment.

### DESCRIPTION OF EMBODIMENTS

Embodiments of an image processing apparatus, an image processing method and a recording medium are described hereinafter with referring figures.

### 1. First Embodiment

A first embodiment of an image processing apparatus, an image processing method and a recording medium is described. Hereinafter, the first embodiment of the image processing apparatus, the image processing method and the recording medium is described by using an image processing apparatus 1 to which the first embodiment of the image processing apparatus, the image processing method and the recording medium is applied.

### 1-1: Configuration of the Image Processing Apparatus 1

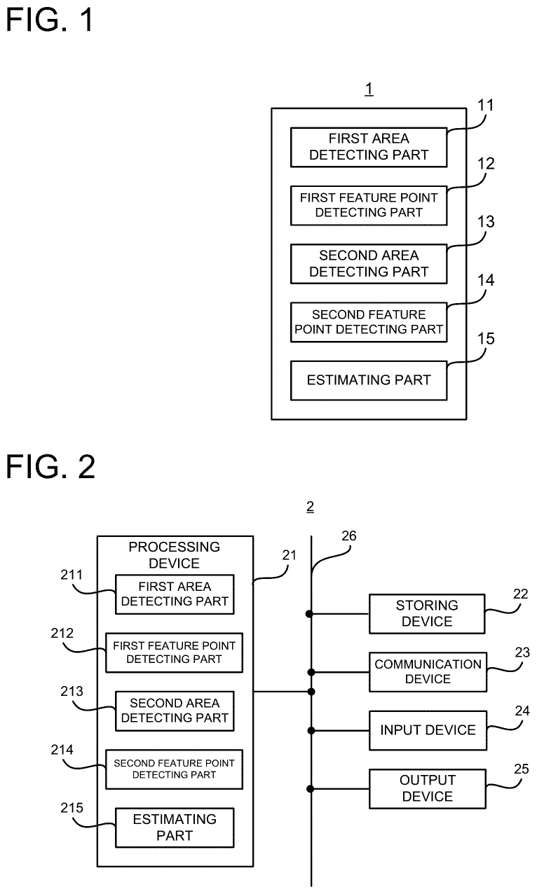

A configuration of the image processing apparatus 1 in the first embodiment is described with referring to FIG. 1. FIG. 1 is a block diagram showing the configuration of the image processing apparatus 1 in the first embodiment.

As shown in FIG. 1, the image processing apparatus 1 comprises a first area detecting part 11, a first feature point detecting part 12, a second area detecting part 13, a second feature point detecting part 14 and an estimating part 15. The first area detecting part 11 detects a first area including at least a part of a person from an image. The first feature point detecting part 12 detects first feature points from the first area. The second area detecting part 13 detects a second area including at least a part of a person from the image, wherein the second area overlaps at least a part of the first area, wherein a size of the second area is different from the first area. The second feature point detecting part 14 detects second feature points from the second area. The estimating part 15 estimates whether or not a person included in the first area and a person included in the second area are the same on the basis of the first feature points and the second feature points.

### 1-2: Technical Effect of the Image Processing Apparatus 1

Since the image processing apparatus 1 in the first embodiment estimates whether or not a person included in the first area and a person included in the second area are the same person on the basis of the first feature points and the second feature points, it is possible to estimate with high accuracy whether or not it is the same person.

### 2: Second Embodiment

A second embodiment of an image processing apparatus, an image processing method and a recording medium is described. Hereinafter, the second embodiment of the image processing apparatus, the image processing method and the recording medium is described by using an image processing apparatus 2 to which the second embodiment of the image processing apparatus, the image processing method and the recording medium is applied.

### 2-1: Configuration of the Image Processing Apparatus 2

A configuration of the image processing apparatus 2 in the second embodiment is described with referring to FIG. 2. FIG. 2 is a block diagram showing the configuration of the image processing apparatus 2 in the second embodiment.

As shown in FIG. 2, the image processing apparatus 2 comprises a processing device 21 and a storage device 22. Furthermore, the image processing apparatus 2 may comprise a communication device 23, an input device 24 and an output device 25. However, the image processing apparatus 2 may not comprise at least one of the communication device 23, the input device 24 and the output device 25. The processing device 21, the storage device 22, the communication device 23, the input device 24 and the output device 25 may be connected through a data bus 26.

The processing device 21 includes at least one of a CPU (Central Processing Unit), a GPU (Graphics Processing Unit), and an FPGA (Field Programmable Gate Array), for example. The processing device 21 reads computer programs. For example, the processing device 21 may read a computer program stored in the storing device 22. For example, the processing device 21 may read a computer program recorded on a computer readable and non-transitory recording medium by using a not shown recording medium reading device (e.g., the input device 24 described later) comprised in the image processing apparatus 2. The processing device 21 may acquire (in other words, download or read) a computer program from a not shown apparatus outside of the image processing apparatus 2 through the communication device 23 (or another communication device). The processing device 21 executes read computer programs. As a result, logical functional blocks for performing operation to be performed by the image processing apparatus 2 are realized in the processing device 21. In other words, the processing device 21 can function as a controller to realizing logical functional blocks for performing operation (i.e., process) to be performed by the image processing apparatus 2.

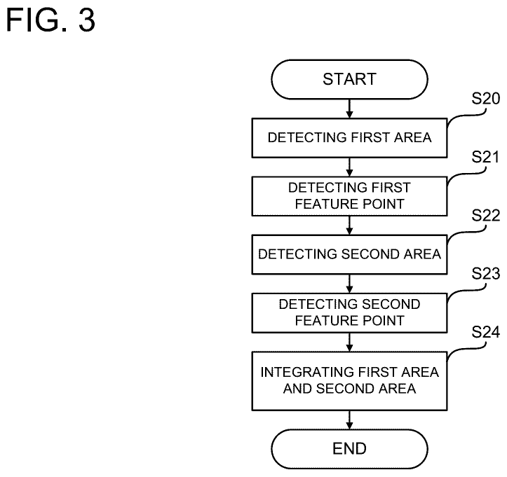

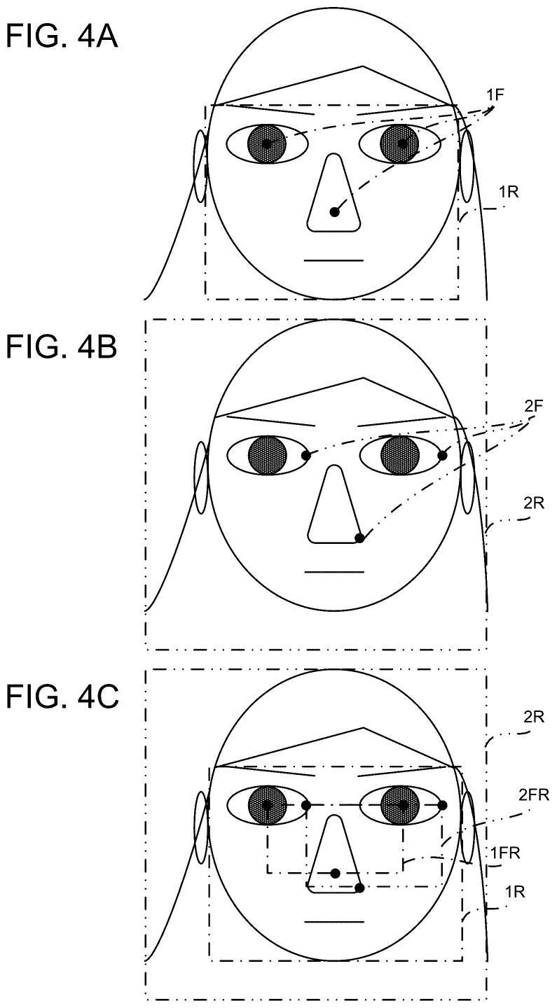

FIG. 2 shows one example of logical functional blocks realized in the processing device 21. As shown in FIG. 2, in the processing device 21, a first area detecting part 211, which is one specific example of a “first area detecting means”, a first feature point detecting part 212, which is one specific example of a “first feature point detecting means”, a second area detecting part 213, which is one specific example of a “second area detecting means”, a second feature point detecting part 214, which is one specific example of a “second feature point detecting means”, and an estimating part 215, which is one of specific example of an “estimating means”, are realized. Operation of each of the first area detecting part 211, the first feature point detecting part 212, the second area detecting part 213, the second feature point detecting part 214 and the estimating part 215 is described later with referring to FIG. 3 and FIG. 4.

The storing device 22 can store desired data. For example, the storing device 22 may temporally store computer programs executed by the processing device 21. The storing device 22 may temporally store data temporally used by the processing device 21 when the processing device 21 executes a computer program. The storing device 22 may store data to be stored for a long time by the image processing apparatus 2. Wherein, the storing device 22 may include at least one of a RAM (Random Access Memory), a ROM (Read Only Memory), a hard disk device, an optical magnetic disk device, an SSD (Solid State Drive), and a disk array device. In other words, the storing device 21 may include non-transitory recording medium.

The communication device 23 can communicate with an apparatus outside of the image processing apparatus 2 through a not shown communication network. The communication device 23 may acquire images that are used in image processing operation from, for example, an imaging apparatus through the communication network.

The input device 24 is a device receiving information input to the image processing apparatus 2 from outside of the image processing apparatus 2. For example, the input device 24 may include an operation device (e.g., at least one of a keyboard, a mouse and a touch panel) which can be operated by an operator of the image processing apparatus 2. For example, the input device 24 may include a reading device, which can read information recorded, as data, on a recording medium being able to externally attach to the image processing apparatus 2.

The output device 25 is a device outputting information to outside of the image processing apparatus 2. The output device 25 may output information as images. In other words, the output device 25 may include a display device (so-called display) which can display an image indicating outputted information. For example, the output device 25 may output information as sound. In other words, the output device 25 may include a sound device (so-called speaker) which can output sound. For example, the output device 25 may output information to papers. In other words, the output device 25 may include a printing device (so-called printer) which can print desired information to papers.

### 2-2: Image Processing Operation Performed by the Image Processing Apparatus 2

Flow of image processing operation performed by the image processing apparatus 2 in the second embodiment is described with referring to FIG. 3 and FIG. 4. FIG. 3 is a flowchart showing the flow of the image processing operation performed by the image processing apparatus 2 in the second embodiment. FIG. 4 is a conceptual scheme of the image processing operation performed by the image processing apparatus 2 in the second embodiment.

As shown in FIG. 3, the first area detecting part 211 detects a first area including at least a part of a person from an image (step S20). The first area may be a face area including a face part of the person. The first area detecting part 211 may detect the face area including the face of the person, as the first area, from the image. The first area detecting part 211 may detect a face area IR exemplified in FIG. 4(a), for example.

The first area detecting part 211 may detect a face area by applying a known face detecting process to image data. The first area detecting part 211 may detect an area having a feature of a face part, as a face area. The area having the feature of the face part may be a characteristic part forming a face such as an eye, a nose and a mouth. A method for detecting a face area performed by the first area detecting part 211 is not restricted. For example, the first area detecting part 211 may detect a face area on the basis of extracted distinctive edges and patterns of the face area.

The first area detecting part 211 may use a neural network, which has machine-learned face areas. The first area detecting part 211 may be consisted of a convolutional neural network (hereinafter, referred to “CNN”). The first area detecting part 211 may be consisted of two CNNs connected in tandem with each other. The first area detecting part 211 may detect a face area IR outputted from a pre-stage CNN and a face area 1R outputted from a post-stage CNN.

In the step S20, when a plurality of face areas 1R, as the first area, are detected, the first area detecting part 211 may select one face area 1R on the basis of reliability of each of face areas 1R. When the first area detecting part 211 detects face areas 1R, each of face areas 1R may be sorted by reliability scores of face areas 1R. The reliability score may indicate a probability of being the face area 1R. The first area detecting part 211 may select a face area 1R, of which a reliability score is the highest, as a face area 1R to be used later processes.

The first area detecting part 211 may suppress overlapping areas using a Non-Maximum Suppression (NMS). The first area detecting part 211 may select 0.45 as a threshold of the NMS, for example.

The first feature point detecting part 212 detects a first feature point from a first face area 1R (step S21). The first feature point detecting part 212 may detect a position of the first feature point from the face area 1R. The first feature point detecting part 212 may detect positions of a plurality of first feature points from the face area 1R. The feature point detecting part 212 may detect a plurality of face feature points 1F exemplified in FIG. 4(a), for example. The first feature point detecting part 212 may detect a plurality of characteristic points in an eye area and a nose area, as the face feature points 1F exemplified in FIG. 4(a), for example. Characteristic points in the eye area are included in edge parts of eyes and in black eyes. Characteristic points in the nose area are included in an apex of nose and in ala nasi edges.

A method for detecting feature points performed by the first feature point detecting part 212 is not restricted. The first feature point detecting part 212 may use a pattern matching, for example. The first feature point detecting part 212 may use a neural network, which has machine-learned eye areas and nose areas. The first feature point detecting part 212 may be consisted of a CNN.

The second area detecting part 213 detects a second area including at least a part of a person from the image, wherein the second area overlaps at least the first area, wherein size of the second area is different from that of the first area (step S22). The second area detecting part 213 may detect a second area including at least a part of a person and the first area from the image. The second area may be a head area including a head of the person. The second area detecting part 213 may detect a head area including a head of the person, as the second area, from the image. The second area detecting part 213 may detect a head area 2R exemplified in FIG. 4(b), for example.

The second area detecting part 213 may detect the head area 2R by applying a known head detecting process to image data. The second area detecting part 213 may an area having a feature of a head as the head area 2R. A method for detecting the head area 2R performed by the second area detecting part 213 is not restricted. The second area detecting part 213 may detect an area including a characteristic part of a head such as hair, for example. The second area detecting part 213 may detect an area having a predetermined shape such as an Ω shape, for example. The second area detecting part 213 may detect the head area 2R on the basis of mainly a shape of an outline. The second area detecting part 213 may detect the head area 2R by using together with detecting parts of a human body such as arms, legs, and body. Since the second area detecting part 213 differs from the first area detecting part 211, the second area detecting part 213 may not depended on detecting characteristic parts consisting of a face. In this case, the second area detecting part 213 may detect the head area 2R even if the first area detecting part 211 does not detect the face area 1R. On the other hand, since the second area detecting part 213 differs from the first area detecting part 211, the second area detecting part 213 may depended on detecting characteristic parts consisting of a face.

The second area detecting part 213 may use a neural network, which has machine-learned the head area 2R. The second area detecting part 213 may be consisted of a CNN. The second area detecting part 213 may be consisted of two CNNs connected in tandem with each other. The second area detecting part 213 may detect a head area 2R outputted from a pre-stage CNN and a head area 2R outputted from a post-stage CNN.

In the step S22, when a plurality of head areas 2R, as the second area, are detected, the second area detecting part 213 may select one head area 2R on the basis of reliability of each of head areas 2R. When the second area detecting part 213 detects head areas 2R, each of head areas 2R may be sorted by reliability scores of head areas 2R. The reliability score may indicate a probability of being the head area 2R. The second area detecting part 213 may select a head area 2R, of which a reliability score is the highest, as a head area 2R to be used later processes.

The second area detecting part 213 may suppress overlapping areas using a Non-Maximum Suppression (NMS). The second area detecting part 213 may select 0.40 as a threshold of the NMS, for example.

The second feature point detecting part 214 detects a second feature point from the head area 2R (step S23). The second feature point detecting part 214 may detect a position of the second feature point from the head area 2R. The second feature point detecting part 214 may detect positions of a plurality of second feature points from the head area 2R. The second feature point detecting part 214 may detect a plurality of head feature points 2F exemplified in FIG. 4(b), for example. The second feature point detecting part 214 may detect characteristic points in an eye area and a nose area, as the head feature point 2F, exemplified in FIG. 4(b), for example. A method for detecting feature points performed by the second feature point detecting part 214 is not restricted. The second feature point detecting part 214 may use a pattern matching, for example. The second feature point detecting part 214 may use a neural network, which has machine-learned eye areas and nose areas. The second feature point detecting part 214 may be consisted of a CNN.

The estimating part 215 integrates the face area 1R and the head area 2R (step S24). The estimating part 215 may perform matching between the face area 1R and the head area 2R. The estimating part 215 estimates whether or not a person included in the face area 1R and a person included in the head area 2R are the same person on the basis of the face feature point 1F and the head feature point 2F. The estimating part 215 may estimate whether or not the person included in the face area 1R and the person included in the head area 2R are the same person on the basis of a position of the face feature point 1F and a position on the head feature point 2F. The estimating part 215 may estimate whether or not the person included in the face area 1R and the person included in the head area 2R are the same person on the basis of a position relationship of feature points. The estimating part 215 may estimate that the closer a distance between feature points is, the more likely that persons are the same. The estimating part 215 may estimate that the person included in the face area 1R and the person included in the head area 2R are the same person from degree of coincidence of each of feature points.

The estimating part 215 may estimate whether or not the person included in the face area 1R and the person included in the head area 2R are the same person on the basis of a first circumscribed shape circumscribing each of face feature points 1F and a second circumscribed shape circumscribing each of head feature points 2F. In this case, a circumscribed shape circumscribing each of feature points may be a circumscribed rectangle circumscribing each of feature points. Wherein, the estimating part 215 may estimate whether or not the person included in the face area 1R and the person included in the head area 2R are the same person on the basis of a state of overlap between a face feature point area 1FR, which is a rectangle circumscribing each of face feature points 1F, and a head feature point area 2FR, which is a rectangle circumscribing each of head feature points 2F. The estimating part 215 may estimate whether or not the person included in the face area 1R and the person included in the head area 2R are the same person on the basis of the face feature point area 1FR and the head feature point area 2FR exemplified in FIG. 4(c), for example.

The estimating part 215 may estimate whether or not the person included in the face area 1R and the person included in the head area 2R are the same person on the basis of an overlap rate between the face feature point area 1FR and the head feature point area 2FR. The estimating part 215 may use an IoU (Intersection over Union: also referred to as “Jaccard coefficient”) as the overlap rate. The IoU is a rate of an overlap part to a union of two areas, it is possible to express IoU=size of the overlap part of the two areas/size of the union of the two areas.

If the face area 1R and the head area 2R are not corresponded, it is likely that erroneous detection of a person increases. In contrast, since the estimating part 215 performs correspondence the face area 1R and the head area 2R, it is possible to suppress erroneous detecting of a person. Moreover, it may be difficult to perform correspondence in a comparative example in which the face area 1R and the head area 2R are simply corresponded to each other. However, since the estimating part 215 performs correspondence on the basis of a first feature point and a second feature point, it is easy to perform correspondence compared with the comparative example.

When the face area 1R is not detected and the head area 2R is detected, the estimating part 215 may not perform correspondence operation. In like manner, when the head area 2R is not detected and the face area 1R is detected, the estimating part 215 may not perform correspondence operation.

### 2-3: Effect by the Image Processing Apparatus 2

For example, when an image has low resolution, it is likely that a CNN erroneous detects a target area and does not detect the target area. On the other hand, when a high resolution image is used in the CNN, accuracy of detection increases, but detection speed becomes low due to increased calculation quantity. For example, there is a demand for lightweight detection engines on such as edge servers. There is a trade-off of accuracy of detection and detection speed.

In contrast, the image processing apparatus 2 in the second embodiment performs at least one of estimating on the basis of a position of a first feature point and a position of a second feature point and estimating on the basis of a first circumscribed shape and a second circumscribed shape. Since the image processing apparatus 2 uses features detected from detection results, it is possible to accurately estimate whether or not a person included in a first area and a person included in a second area are the same person. Thus, the image processing apparatus 2 can restrict erroneous detecting a target area. Furthermore, the image processing apparatus 2 can restrict undetecting a target area by detecting a second area including a first area. Therefore, image processing apparatus 2 can accurately detect a target area even if an image is low resolution. Since a high resolution image is not needed, the image processing apparatus 2 can increase accuracy of detection without slowing down detection speed.

### [3: Third Embodiment

A third embodiment of an image processing apparatus, an image processing method and a recording medium is described. Hereinafter, the third embodiment of the image processing apparatus, the image processing method and the recording medium is described by using an image processing apparatus 3 to which the third embodiment of the image processing apparatus, the image processing method and the recording medium is applied.

### 3-1: Configuration of the Image Processing Apparatus 3

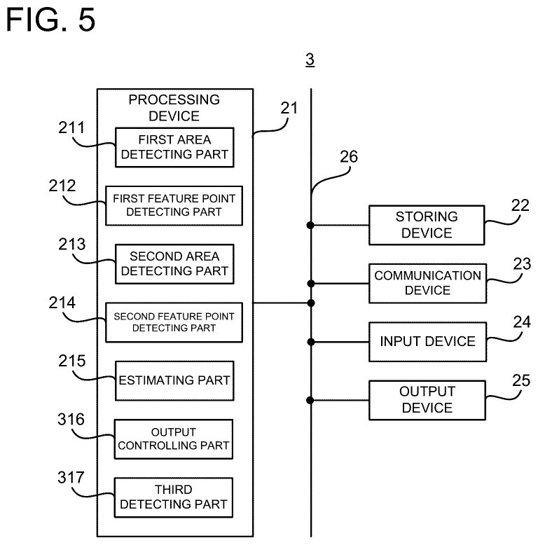

A configuration of the image processing apparatus 3 in the third embodiment is described with referring to FIG. 5. FIG. 5 is a block diagram showing the configuration of the image processing apparatus 3 in the third embodiment.

As shown in FIG. 5, the image processing apparatus 3 in the third embodiment comprises the processing device 21 and the storage device 22 in similar to the image processing apparatus 2 in the second embodiment. Furthermore, the image processing apparatus 3 may comprise the communication device 23, the input device 24 and the output device 25 in similar to the image processing apparatus 2 in the second embodiment. However, the image processing apparatus 3 may not comprise at least one of the communication device 23, the input device 24 and the output device 25. The image processing apparatus 3 in the third embodiment differs that the processing device 21 has an output controlling part 316 and a third detecting part 317 compared with the image processing apparatus 2 in the second embodiment. Other features of the image processing apparatus 3 may be the same as other features of the image processing apparatus 2 in the second embodiment.

### 3-2: Image Processing Operation Performed by the Image Processing Apparatus 3

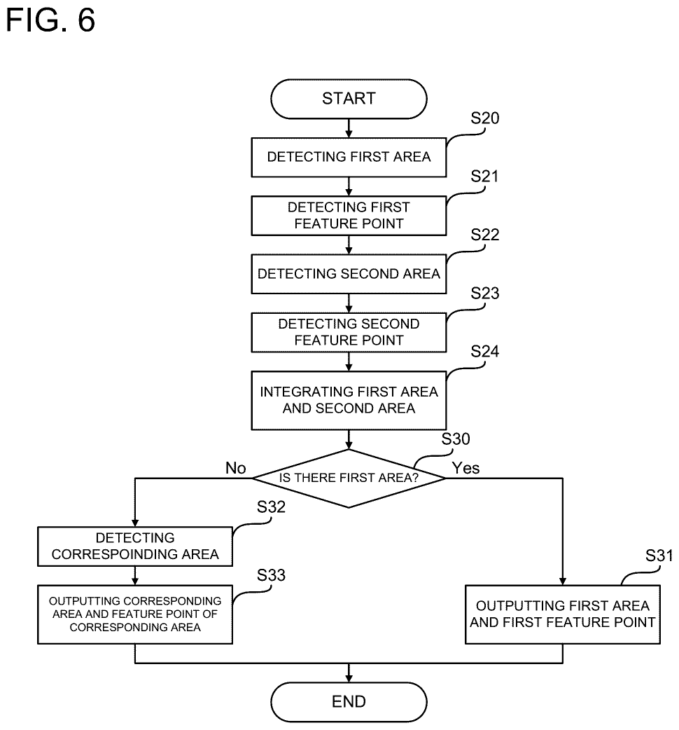

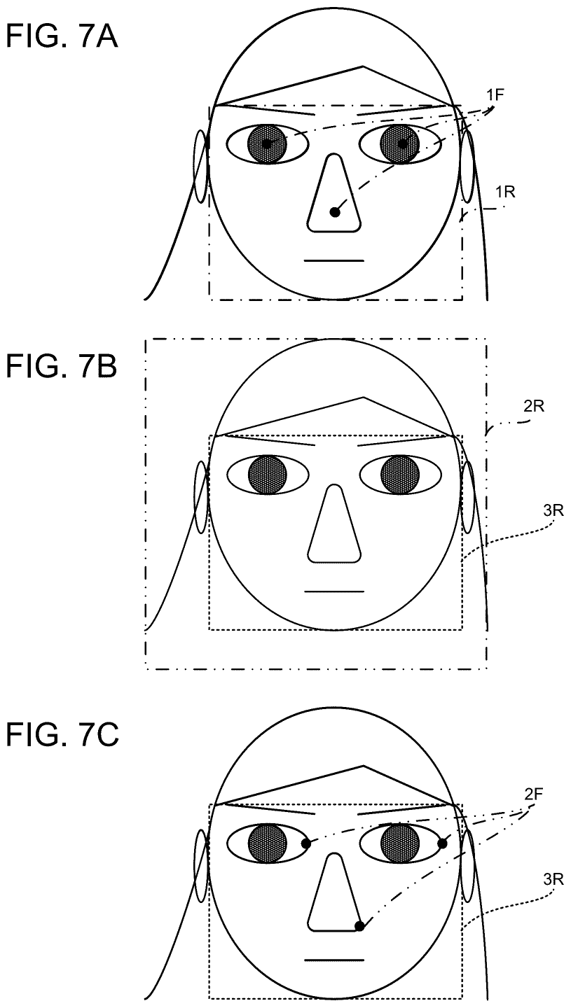

Flow of image processing operation performed by the image processing apparatus 3 is described with referring to FIG. 6 and FIG. 7. FIG. 6 is a flowchart showing the flow of the image processing operation performed by the image processing apparatus 3 in the third embodiment. FIG. 7 is a conceptual scheme of the image processing operation performed by the image processing apparatus 3 in the third embodiment.

As shown in FIG. 6, the first area detecting part 211 detects a face area 1R including at least a part of a person from an image (step S20). The first feature point detecting part 212 detects a face feature point 1F from the face area 1R (step S21). The second area detecting part 213 detects a head area 2R including at least a part of a person and including the face area 1F from the image (step S22). The second feature point detecting part 214 detects a head feature point 2F from the head area 2R (step S23). The estimating part 215 integrates the face area 1R and the head area 2R (step S24).

The output controlling part 316 determines whether or not there is the face area 1R (step S30). The output controlling part 316 may determine whether or not the first area detecting part 211 detects a face area 1R. Wherein, when a face area 1R is not detected and a head area 2R is detected, it may skip the step S30 and proceed to a step S32.

When there is the face area 1R (step S30: Yes), i.e., when the first area detecting part 211 detects the face area 1R, the output controlling part 316 outputs the face area 1R and a face feature point 1F (step S31). A case, in which there is the face area 1R, may include a case, in which the first area detecting part 211 detects the face area 1R and the second area detecting part 213 does not detect a head area 2R, and a case, in which the first area detecting part 211 detects the face area 1R and the second area detecting part 213 detects the head area 2R. The output controlling part 316 may output the face area 1R integrated with the head area 2R in the step S24 and the face feature point 1F. The output controlling part 316 may search for a pair having an IoU more than or equal to 0.01 and having the maximum, and may output a corresponded face area 1R and a corresponded face feature point 1F. The output controlling part 316 may output the face area 1R and the face feature point 1F exemplified in FIG. 7(a).

On the other hand, when there is not the face area 1R (step S30: No), i.e., when the first area detecting part 211 does not detect the face area 1R, the third detecting part 317 detects a corresponding area 3R corresponding to the face area 1R from the head area 2R (step S32). A case, in which there is not the face area 1R, may include a case, in which the first area detecting part 211 does not detect the face area 1R and the second area detecting part 213 detects the head area 2R. The third detecting part 317 may detect the corresponding area 3R corresponding to the face area 1R exemplified in FIG. 7(b). The third detecting part 317 may detect a square having a side, which is equal to greater one of twice a width and four times height of a head feature pint area 2FR, as a new face area 1R.

The output controlling part 316 outputs the corresponding area 3R and a feature point included in the corresponding area 3R (step S33). The feature point included in the corresponding area 3R may be the same as the head feature point 2F. The output controlling part 316 may output the corresponding area 3R and the head feature point 2F exemplified in FIG. 7(c).

The output controlling part 316 may perform data shaping by integrating a plurality of rectangles and may output a data shaping result. Data shaping operation may include a sorting process, a rounding process, an NMS process, an inclusion relationship process and a crass assignment process, for example. The sorting process may be a process for sorting all detected areas in order of reliability score. The rounding process may be a process for rounding coordinates that are out of an image int the image, for example. The NMS process may be a process for suppressing overlapping areas by selecting 0.45 as a threshold value of the NMS, for example. The inclusion process may be a process for leaving an area with a higher confidence score among areas with a complete inclusion relationship, for example. The class assignment process may be a process for assigning the same class ID to a result derived from a head as to a result derived from a face, for example.

### 3-3: Effect by the Image Processing Apparatus 3

The image processing apparatus in the third embodiment detects a corresponding area corresponding to a first area from a second area when the first area is not detected, and outputs the corresponding area and a feature point included in the corresponding area. By this, it is possible to acquire a first area of a person and a feature point included in the first area even if the first area is not detected.

A head is larger than a face. Thus, since it is possible to detect the head area 2R, which is larger than the face area 1R, the head area 2R may include more reference information compared with the face area 1R. The first area detecting part 211 and the second area detecting part 213 differ in a detecting method. Therefore, the second area detecting part 213 may detect the head area 2R even if the first area detecting part 211 does not detect the face area 1R.

The image processing apparatus 3 can prevent undetecting a target area by detecting the head area 2R and converting the head area 2R to a face area 1R when a face area 1R is not detected. By this, the image processing apparatus 3 can detect an area corresponding to the face area 1R in a situation in which the face area 1R is not detected. In other words, the image processing apparatus 3 can improve undetecting the face area 1R in a case in which an image is low resolution. The image processing apparatus 3 can improve undetecting the face area 1R in a case in which size of an image is nearly the minimum size of detection limit. In other words, the image processing apparatus 3 can reduce size of detection limit of an image, and can expand detectable size.

Wherein, the first area detecting part 211 and the first feature point detecting part 212 may be consisted of the same CNN. The second area detecting part 213 and the second feature point detecting part 214 may be consisted of the same CNN. Furthermore, the first area detecting part 211, the first feature point detecting part 212, the second area detecting part 213 and the second feature point detecting part 214 may be consisted of the same CNN. Moreover, detecting a first area and detecting a second area may be performed at the same time.

### 4: Fourth Embodiment

A fourth embodiment of an image processing apparatus, an image processing method and a recording medium is described. Hereinafter, the fourth embodiment of the image processing apparatus, the image processing method and the recording medium is described by using an image processing apparatus 4 to which the fourth embodiment of the image processing apparatus, the image processing method and the recording medium is applied.

The image processing apparatus 4 in the fourth embodiment differs that a first area detected by the first area detecting part 211 and a second area detected by the second area detecting part 213 compared with the image processing apparatus 2 in the second embodiment and the image processing apparatus 3 in the third embodiment. Other features of the image processing apparatus 4 may be the same as other features of at least of the image processing apparatus 2 and the image processing apparatus 3.

In the fourth embodiment, the first area detecting part 211 may detect a head area including a head of a person as a first area. The second area detecting part 213 may detect at least one of an upper body area and a whole body area of a person as a second area.

Detecting the head area is useful for tracking operation of a person. The tracking operation of the person may be applied to such as so-called gateless authentication in which a person authentication is performed when the person is in a predetermined area. Detecting the upper body area and/or the whole body area is useful for cover operation of the tracking operation of the person such as when a head area is not detected. For example, when the second area detecting part 213 detects the upper body area or the whole body area even if the first area detecting part 211 does not detect the head area, it is possible to continue the tracking operation of the person by determining the same person referring to a feature of a person included in the upper body area or the whole body area.

Wherein, in the fourth embodiment, the first area detecting part 211 may detect a face area including a face of a person as a first area, and the second area detecting part 213 may detect an upper body area and/or a whole body area of a person as a second area.

### 5: Fifth Embodiment

A fifth embodiment of an image processing apparatus, an image processing method and a recording medium is described. Hereinafter, the fifth embodiment of the image processing apparatus, the image processing method and the recording medium is described by using an image processing apparatus 5 to which the fifth embodiment of the image processing apparatus, the image processing method and the recording medium is applied.

### 5-1: Configuration of the Image Processing Apparatus 5

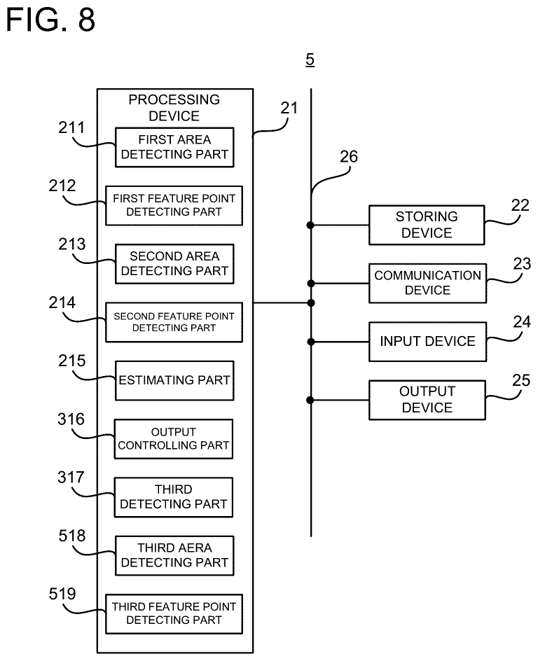

A configuration of the image processing apparatus 5 in the fifth embodiment is described with referring to FIG. 8. FIG. 8 is a block diagram showing the configuration of the image processing apparatus 5 in the fifth embodiment.

As shown in FIG. 8, the image processing apparatus 5 in the fifth embodiment differs that the processing device 21 has a third area detecting part 518 and a third feature point detecting part 519 compared with the image processing apparatus 3 in the third embodiment. Other features of the image processing apparatus 5 may be the same as other features of the image processing apparatus 3 in the third embodiment.

### 5-2: Image Processing Operation Performed by the Image Processing Apparatus 5

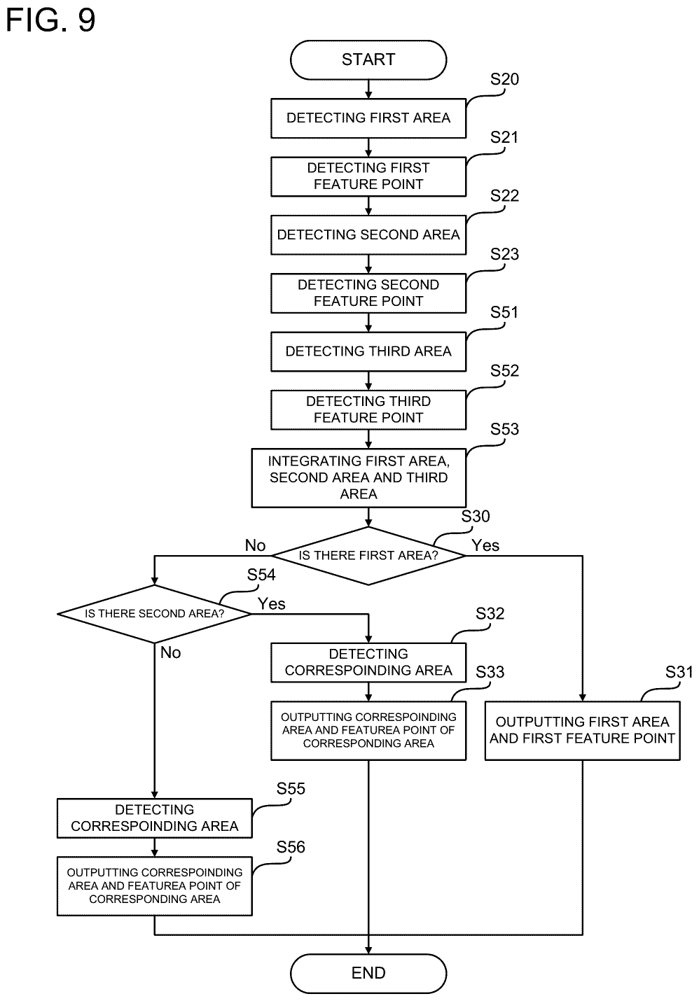

Flow of an image processing operation performed by the image processing apparatus 5 in the fifth embodiment with referring to FIG. 9. FIG. 9 is a flowchart showing the flow of the image processing operation performed by the image processing apparatus 5 in the fifth embodiment.

As shown in FIG. 9, the first area detecting part 211 detects a face area as a first area (step S20). The first feature point detecting part 212 detects a face feature point, as a first feature point, from the face area (step S21). The second area detecting part 213 detects a head area as a second area (step S22). The second feature point detecting part 214 detects a head feature point, as a second feature point, from the head area (step S23).

The third area detecting part 518 may detect a third area including at least a part of a person from an image and including the second area. The third area may be an upper body area or a whole body area of the person. The third area detecting part 518 may detect an upper body area or a whole body area, as the third area, from an image.

The third feature point detecting part 519 detects a third feature point from an upper body area or a whole body area (step S52). The third feature point detecting part 519 may detect a position of the third feature point from the upper body area or the whole body area. The third feature point detecting part 519 may detect positions of third feature points from the upper body area or the whole body area.

The estimating part 215 integrates the face area, the head area, and the upper body area or the whole body area (step S53). The estimating part 215 may perform matching of the face area, the head area, and the upper body area or the whole body area. The estimating part 215 estimates whether or not a person included in the face area, a person included in the head area and a person included in the upper body area or the whole body area are the same person on the basis of the face feature point, the head feature point and the third feature point. The estimating part 215 may estimate whether or not a person included in the face area, a person included in the head area and a person included in the upper body area or the whole body area are the same person on the basis of a position of the face feature point, a position of the head feature point and a position of the third feature point. The estimating part 215 may estimate whether or not a person included in the face area, a person included in the head area and a person included in the upper body area or the whole body area are the same person on the basis of a position relationship among feature points. The estimating part 215 may estimate that the closer a distance between feature points is, the more likely that persons are the same. The estimating part 215 may estimate that it is each of a person included in the face area, a person included in the head area and a person included in the upper body area or the whole body area from degree of coincidence of each of feature points. Moreover, the estimating part 215 may estimate whether or not a person included in the face area, a person included in the head area and a person included in the upper body area or the whole body area are the same person on the basis of a circumscribed shape circumscribing each of feature points in similar to above-mentioned embodiments.

The output controlling part 316 determines whether or not there is the face area 1R (step S30). When there is the face area (step S30: Yes), the output controlling part 316 outputs the face area and a face feature point (step S31).

When there is not the face area (step S30: No), the output controlling part 316 determines whether or not there is the head area (step S54). When there is the head area (step S54: Yes), the third detecting part 317 detects a corresponding area derived from the head area corresponding to the face area from the head area (step S32). The output controlling part 316 outputs the corresponding area derived from the head area and a feature point included in the corresponding area derived from the head area (step S33).

When there is not the head area (step S54: No), the third detecting part 317 detects a corresponding area derived from the upper body area or the whole body area corresponding to the face area from the upper body area or the whole body area (step S55). The output controlling part 316 outputs the corresponding area derived from the upper body area or the whole body area and a feature point included in the corresponding area derived from the upper body area or the whole body area (step S56).

The operation of the image processing apparatus in each of the above-mentioned embodiments may be rephrased as detecting objects of a plurality of classes of inclusion relationship, detecting feature points from detected objects, estimating a pair of objects on the basis of a detecting result, estimating whether or not detecting results of different classes are things of the same person. Especially, the operation performed by the image processing apparatus in the third embodiment may be rephrased as estimating an area of an object of an included class.

The image processing apparatus in each of the above-mentioned embodiment is suitable for use in tracking and face recognition operations.

### 6: Supplementary Note

In regard to embodiments described above, the following supplementary notes may be further described.

### Supplementary Note 1

An image processing apparatus comprising:
a first area detecting means for detecting a first area including at least a part of a person from an image;
a first feature point detecting means for detecting first feature points from the first area;
a second area detecting means for detecting a second area including at least a part of a person from the image, wherein the second area overlapping at least a part of the first area, wherein a size of the second area being different from the first area;
a second feature point detecting means for detecting second feature points from the second area; and
an estimating means for estimating whether or not a person included in the first area and a person included in the second area are the same person on the basis of the first feature points and the second feature points.

### Supplementary Note 2

The image processing apparatus according to the supplementary note 1, wherein the estimating means estimates whether or not the person included in the first area and the person included in the second area are the same person on the basis of a first circumscribed shape circumscribing each of the first feature points and a second circumscribed shape circumscribing each of the second feature points.

### Supplementary Note 3

The image processing apparatus according to the supplementary note 1 or 2, further comprising:
an outputting means for outputting the first area and feature points included in the first area; and
a third detecting means for detecting a corresponding area corresponding to the first area from the second area,
wherein, the outputting means
outputs the first area and the first feature points when the first area detecting means detects the first area, and
outputs the corresponding area and feature points included in the corresponding area when the first area detecting means does not detect the first area.

### Supplementary Note 4

The image processing apparatus according to any one of supplementary notes 1to 3, wherein
the second area detecting means detects the second area including at least the part of the person from the image, wherein the second area includes the first area.

### Supplementary Note 5

The image processing apparatus according to the supplementary note 4, wherein the first area detecting means detects a face area including a face of the person, as the first area, from the image, and
the second area detecting means detects a head area including a head of the person, as the second area, from the image.

### Supplementary Note 6

The image processing apparatus according to any one of supplementary notes 1 to 5, wherein
the first area detecting means selects one first area on the basis of reliability of each of a plurality of the first areas when the plurality of the first areas are detected, and
the second area detecting means selects one second area on the basis of reliability of each of a plurality of the second areas when the plurality of the second areas are detected.

### Supplementary Note 7

An image processing method including:
detecting a first area including at least a part of a person from an image: detecting first feature points from the first area;
detecting a second area including at least a part of a person from the image, wherein the second area overlapping at least a part of the first area, wherein a size of the second area being different from the first area;
detecting second feature points from the second area; and estimating whether or not a person included in the first area and a person included in the second area are the same person on the basis of the first feature points and the second feature points.

### Supplementary Note 8

A recording medium on which a computer program is recorded, wherein the computer program makes a computer perform an image processing method including: detecting a first area including at least a part of a person from an image, detecting first feature points from the first area, detecting a second area including at least a part of a person from the image, wherein the second area overlapping at least a part of the first area, wherein a size of the second area being different from the first area, detecting second feature points from the second area, and estimating whether or not a person included in the first area and a person included in the second area are the same person on the basis of the first feature points and the second feature points.

At least a part of components of each of the above-mentioned embodiments may be combined with at least another part of components of each of the above-mentioned embodiments. A part of components of each of the above-mentioned embodiments may be not used. In addition, to the extent permitted by law, the disclosures of all documents (e.g., publications) cited in this disclosure above are incorporated by reference into this disclosure.

This disclosure can appropriately be changed within limits being not contrary to summary of inventions or ideas, that can be read from the scope of claims and all of the specification, an image processing apparatus, an image processing method and a recording medium with such changes are also included in technical ideas of this disclosure.

### EXPLANATION OF SYMBOL

1, 2, 3 Image processing apparatus
11, 211 First area detecting part
12, 212 First feature point detecting part
13, 213 Second area detecting part
14, 214 Second feature point detecting part
15, 215 Estimating part
1R Face area
1F Face feature point
1FR Face feature point area
2R Head area
2F Head feature point
2FR Head feature point area
316 Output controlling part
317 Third detecting part
3R Corresponding area
518 Third area detecting part
519 Third feature point detecting part

What is claimed is:

1. An image processing apparatus comprising:
at least one memory configured to store instructions; and
at least one processor configured to execute the instructions to:
detect a first area including at least a part of a person from an image;
detect first feature points from the first area;
detect a second area including at least a part of a person from the image, wherein the second area overlapping at least a part of the first area, wherein a size of the second area being different from the first area;
detect second feature points from the second area; and
estimate whether or not a person included in the first area and a person included in the second area are the same person on the basis of the first feature points and the second feature points.

2. The image processing apparatus according to claim 1, wherein
the at least one processor is configured to execute the instructions to estimate whether or not the person included in the first area and the person included in the second area are the same person on the basis of a first circumscribed shape circumscribing each of the first feature points and a second circumscribed shape circumscribing each of the second feature points.

3. The image processing apparatus according to claim 1
wherein the at least one processor is configured to execute the instructions to:
output the first area and feature points included in the first area; and
detect a corresponding area corresponding to the first area from the second area,
output the first area and the first feature points when the first area is detected, and
output the corresponding area and feature points included in the corresponding area when the first area is not detected.

4. The image processing apparatus according to claim 1, wherein
the at least one processor is configured to execute the instructions to detect the second area including at least the part of the person from the image, wherein the second area includes the first area.

5. The image processing apparatus according to claim 4, wherein
the at least one processor is configured to execute the instructions to:
detect a face area including a face of the person, as the first area, from the image, and
detect a head area including a head of the person, as the second area, from the image.

6. The image processing apparatus according to claim 1, wherein
the at least one processor is configured to execute the instructions to:
select one first area on the basis of reliability of each of a plurality of the first areas when the plurality of the first areas are detected, and
select one second area on the basis of reliability of each of a plurality of the second areas when the plurality of the second areas are detected.

7. An image processing method including:
detecting a first area including at least a part of a person from an image;
detecting first feature points from the first area;
detecting a second area including at least a part of a person from the image, wherein the second area overlapping at least a part of the first area, wherein a size of the second area being different from the first area;
detecting second feature points from the second area; and
estimating whether or not a person included in the first area and a person included in the second area are the same person on the basis of the first feature points and the second feature points.

8. A non-transitory recording medium on which a computer program is recorded, wherein the computer program makes a computer perform an image processing method including: detecting a first area including at least a part of a person from an image, detecting first feature points from the first area, detecting a second area including at least a part of a person from the image, wherein the second area overlapping at least a part of the first area, wherein a size of the second area being different from the first area, detecting second feature points from the second area, and estimating whether or not a person included in the first area and a person included in the second area are the same person on the basis of the first feature points and the second feature points.

9. The image processing apparatus according to claim 2,
wherein the at least one processor is configured to execute the instructions to:
output the first area and feature points included in the first area,
detect a corresponding area corresponding to the first area from the second area,
output the first area and the first feature points when the first area is detected, and
output the corresponding area and feature points included in the corresponding area when the first area is not detected.

10. The image processing apparatus according to claim 2, wherein
the at least one processor is configured to execute the instructions to detect the second area including at least the part of the person from the image, wherein the second area includes the first area.

11. The image processing apparatus according to claim 3, wherein
the at least one processor is configured to execute the instructions to detect the second area including at least the part of the person from the image, wherein the second area includes the first area.

12. The image processing apparatus according to claim 9, wherein
the at least one processor is configured to execute the instructions to detect the second area including at least the part of the person from the image, wherein the second area includes the first area.

13. The image processing apparatus according to claim 10, wherein
the at least one processor is configured to execute the instructions to:
detect a face area including a face of the person, as the first area, from the image, and
detect a head area including a head of the person, as the second area, from the image.

14. The image processing apparatus according to claim 11, wherein
the at least one processor is configured to execute the instructions to:
detect a face area including a face of the person, as the first area, from the image, and
detect a head area including a head of the person, as the second area, from the image.

15. The image processing apparatus according to claim 12, wherein
the at least one processor is configured to execute the instructions to:
detect a face area including a face of the person, as the first area, from the image, and
detect a head area including a head of the person, as the second area, from the image.

16. The image processing apparatus according to claim 2, wherein
the at least one processor is configured to execute the instructions to:
select one first area on the basis of reliability of each of a plurality of the first areas when the plurality of the first areas are detected, and
select one second area on the basis of reliability of each of a plurality of the second areas when the plurality of the second areas are detected.

17. The image processing apparatus according to claim 3, wherein
the at least one processor is configured to execute the instructions to:
select one first area on the basis of reliability of each of a plurality of the first areas when the plurality of the first areas are detected, and
select one second area on the basis of reliability of each of a plurality of the second areas when the plurality of the second areas are detected.

18. The image processing apparatus according to claim 4, wherein
the at least one processor is configured to execute the instructions to:
select one first area on the basis of reliability of each of a plurality of the first areas when the plurality of the first areas are detected, and
select one second area on the basis of reliability of each of a plurality of the second areas when the plurality of the second areas are detected.

19. The image processing apparatus according to claim 5, wherein
the at least one processor is configured to execute the instructions to:
select one first area on the basis of reliability of each of a plurality of the first areas when the plurality of the first areas are detected, and
select one second area on the basis of reliability of each of a plurality of the second areas when the plurality of the second areas are detected.

20. The image processing apparatus according to claim 9, wherein
the at least one processor is configured to execute the instructions to:
select one first area on the basis of reliability of a plurality of the each of first areas when the plurality of the first areas are detected, and
select one second area on the basis of reliability of each of a plurality of the second areas when the plurality of the second areas are detected.
